(19) United States
(12) Patent Application Publication
(10) Pub. No.: US 2011/0095634 A1
(43) Pub. Date: Apr. 28, 2011

(54) ELECTRIC MACHINE COMPRISING A STATOR SUPPORT FOR A HYBRID DRIVE TRAIN

(75) Inventors: Martin Lamke, Ravensburg (DE); Rayk Hoffmann, Friedrichshafen (DE); Thomas Gnandt, Horgenzell (DE)

(73) Assignee: ZF FRIEDRICHSHAFEN AG, Friedrichshafen (DE)

(21) Appl. No.: 12/996,131

(22) PCT Filed: May 27, 2009
(86) PCT No.: PCT/EP09/56454

§ 371 Date: Dec. 3, 2010

(30) Foreign Application Priority Data
Jun. 16, 2008 (DE) 10 2008 002 443.0

(51) Int. Cl. H02K 5/04

(52) U.S. Cl. 310/91

(57) ABSTRACT

An electric machine (2) having a stator support (5) for a hybrid drive train of a vehicle, in particular a utility vehicle, with a transmission housing (3), for accommodating the transmission, and a hybrid housing (4), for accommodating the electric machine (2), such that the stator support (5) is formed integrally with an attachment for fastening to the hybrid housing (4) and the transmission housing (3).

This application is a National Stage completion of PCT/EP2009/056454 filed May 27, 2009, which claims priority from German patent application serial no. 10 2008 002 443.0 filed Jun. 16, 2008.

### FIELD OF THE INVENTION

The present invention concerns an electric machine with a stator support for a hybrid drive train.

### BACKGROUND OF THE INVENTION

From automotive technology vehicles with a hybrid drive train, in particular utility vehicles, are known. The hybrid drive train usually comprises an internal combustion engine coupled to a transmission via a clutch. As an additional drive source an electric machine is provided and arranged for example on the transmission input side. In this way the vehicle can be driven by the internal combustion engine and/or by the electric machine. The electric machine can be operated as a motor or as a generator. As the transmission, in this case an automated transmission is provided.

In the known hybrid drive trains the electric machine is integrated in the transmission housing. For this it is necessary, for example, that the stator support of the electric machine is of correspondingly elaborate design enabling it to be integrated in the transmission housing. In addition structural modifications of the transmission housing are needed in order to adapt it to the stator support and to the other components of the electric machine. Thus, the ordinary transmission housings used in vehicles having no electric machine cannot be used.

SUMMARY OF THE INVENTION

The purpose of the present invention is to propose an electric machine of the type described at the start, which is as simply designed as possible and which allows the electric machine to be integrated in the transmission housing without design modifications.

The stated objective of the invention can be achieved by an electric machine with a stator support for a hybrid drive train having a transmission housing to accommodate the transmission and a hybrid housing to accommodate the electric machine and, for example, the clutch of a vehicle, in particular a utility vehicle, such that the stator support is made integrally with an attachment for fastening onto the hybrid housing and the transmission housing. This produces a particularly simply designed stator support for the electric machine, which combines the various necessary connections and interfaces in only a single component.

In one possible embodiment variant of the invention it can be provided that a flange collar or the like is formed on the stator support as the attachment. The attachment can also be provided as a detachable element on the stator support. When the attachment is formed as a flange collar, the stator support can be clamped between the hybrid housing and the transmission housing in the most simple manner without having to make structural modifications to the transmission housing. In this way an adaptively modified electric machine is proposed, which can be fitted onto already existing transmission housings that can, for example, also be used in other drive trains.

Preferably the flange collar on the like can have a plurality of axial through-bores or the like distributed around its circumference. These through-bores allow the passage of bolts that are provided, for example, for fastening the hybrid housing to the usual type of transmission housing. Advantageously, in this way no additional assembly effort is entailed for fitting the stator support to the transmission housing.

According to a possible further development of the invention, it can be provided that the shape of the flange collar is in each case adapted to the axial contour of the transmission housing and the hybrid housing. In this way the stator support realizes the SAE connections or SAE interfaces usually provided, for example, on a crankcase of the internal combustion engine for fastening onto the transmission housing. Thus, the stator support can be interposed axially between the hybrid housing and the transmission housing, and only the axial length of the hybrid drive train will then be increased by the axial width of the stator support. In other respects the transmission housing or the hybrid housing can be fitted onto a standard crankcase of the internal combustion engine without modifications.

It is possible for the flange collar of the stator support to have a plurality of cut-outs or the like, in order advantageously to reduce the weight of the stator support. Furthermore, a suitably located cut-out can form a passage for the throw-out tappet or thrust rod of the clutch actuating mechanism if the clutch control unit is not arranged centrally.

A related possible design of the invention can provide that the stator support can be connected to a transport security element. The transport security element can for example be in the form of a cup-shaped component fixed, on the one hand, to the stator support and, on the other hand, to the rotor of the electric machine in order to ensure safety during transport and assembly. This prevents the stator support from coming into contact with the rotor of the electric machine due to the attractive force of the permanent magnets of the electric machine during transport, assembly, or replacement. Transport security elements designed in other ways can also be used. After transport or during assembly, the transport security element can be removed again from the stator support in the most simple manner.

Particularly advantageously, the stator support of the electric machine according to the invention can be made as an integrated cooling jacket or the like. For that purpose the stator support can for example comprise at least one integrated cooling duct of the cooling system of the electric machine. Preferably, on at least one main bearing point or the like of the stator support, venting means can be provided, for example in the form of a venting screw or similar, in order to vent the cooling system of the electric machine. The main bearing point is a recess formed during the casting of the stator support. Thus, the proposed stator support is designed so that the cooling system of the electric drive can be vented.

In another further development of the invention, it can be provided that the stator support, for example in its peripheral area, has a cooling duct connection, an electric current terminal and/or a temperature sensor connection. This extends the functionality of the stator support and thereby saves otherwise necessary additional components. In this way all the interfaces required for the electric drive can be located on the stator support. Preferably, a rotor position sensor can also be arranged in or on the stator support.

For example, a machine with an internal rotor can be used as the electric machine. However, other structures can also be used for the electric machine.

### BRIEF DESCRIPTION OF THE DRAWINGS

Below, the present invention is explained in greater detail with reference to the drawings, which show:

FIG. 1: Sectional view of an electric machine with a stator support in a hybrid drive train

FIG. 2: Three-dimensional isolated-component view of the stator support of the electric machine

FIG. 3: Three-dimensional view of the side of the electric machine facing toward the transmission

FIG. 4: Three-dimensional view of the side of the electric machine facing toward the internal combustion engine

FIG. 5: Partially sectioned view of the electric machine, and

FIG. 6: Three-dimensional partial view of the stator support with a coolant connection.

### DETAILED DESCRIPTION OF THE PREFERRED EMBODIMENTS

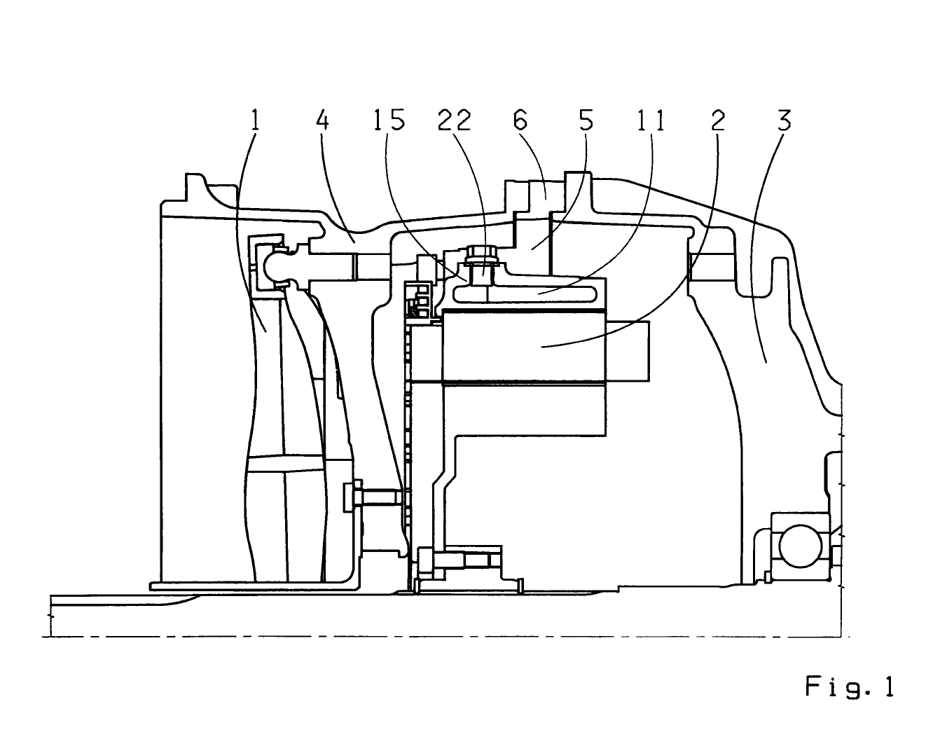

FIG. 1 shows, as an example, a partial view of a hybrid drive train; in the description of the figure some components known per se are not indexed.

In a familiar way, the hybrid drive train comprises an internal combustion engine (not shown), which is coupled by means of a clutch (indicated only in part) to a transmission, the clutch fork 1 provided for actuating the clutch being shown. Depending on the embodiment concerned, the transmission may be a manual-shift gearbox, an automated shift transmission or the like. The transmission is arranged in a transmission housing 3. The electric machine 2 and the clutch are accommodated in a hybrid housing 4 arranged between a crankcase (not shown) of the internal combustion engine and the transmission housing 3.

The proposed electric machine 2 comprises a stator support 5 formed integrally with an attachment or the like for fastening onto the hybrid housing 4 and the transmission housing 3. Thus, the electric machine 2 designed according to the invention can be adapted to the transmission housing 3 so that an ordinary transmission housing 3, also used in drive trains without an electric drive, can be used without the need for structural modifications.

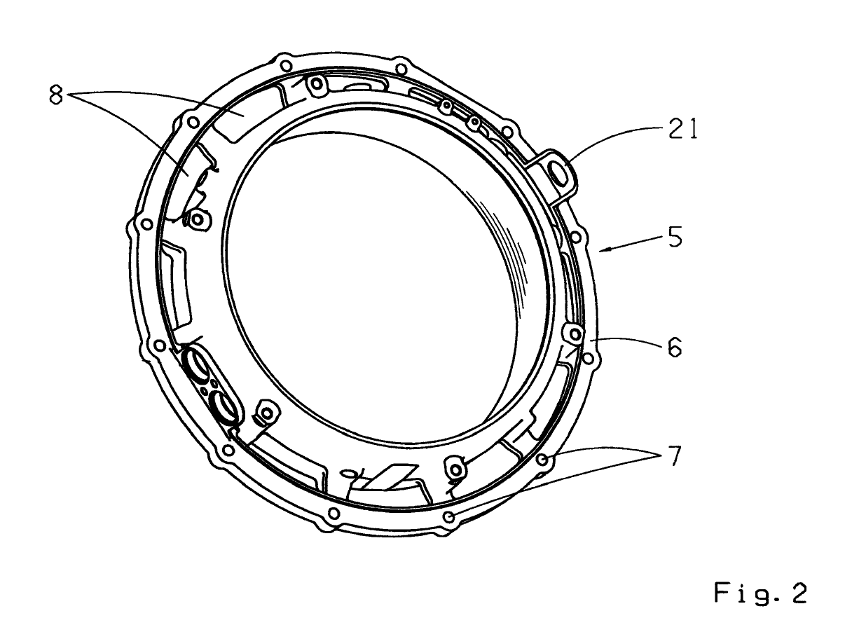

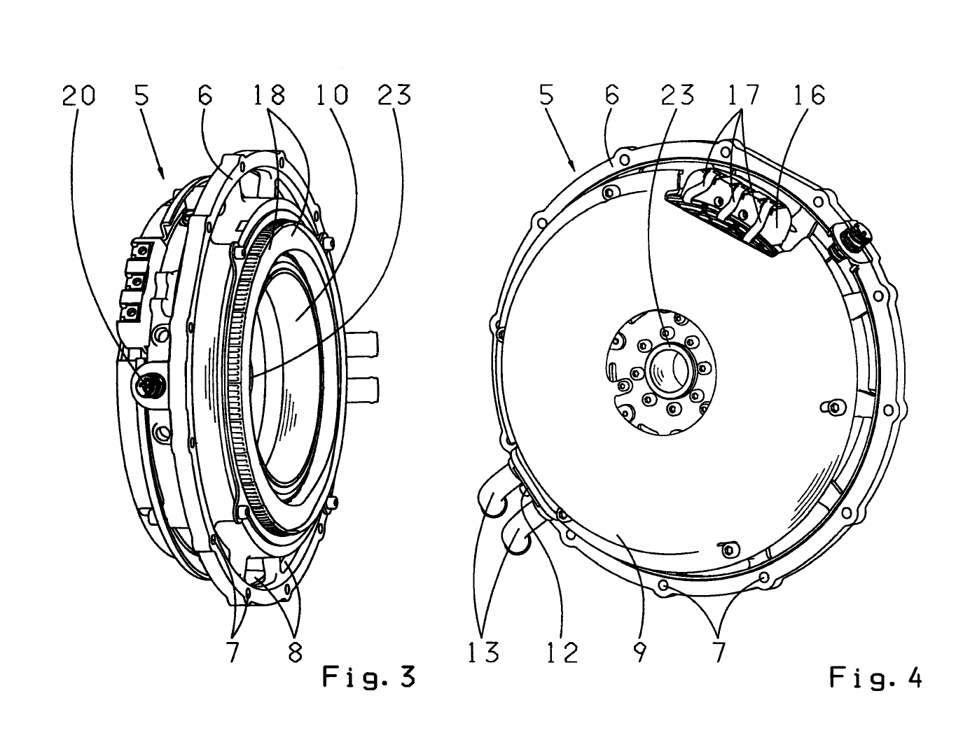

The design of the stator support 5 according to the invention can be seen particularly clearly in FIGS. 2, 3 and 4. As the fastening attachment a flange collar 6 is formed radially on the outside on the stator support 5. The flange collar 6 has a plurality of axially orientated through-bores 7 distributed around its circumference. The through-bores 7 receive bolts (not shown) to fasten the stator support 5 between the hybrid housing 4 and the transmission housing 3.

The shape of the flange collar 6 is adapted to the respective axially orientated contours of the transmission housing 3 and the hybrid housing 4. In this way the stator support 5 can be clamped axially between the transmission housing 3 and the hybrid housing 4, as can be seen particularly clearly in FIG. 1.

Thanks to the design of the stator support of the electric machine 2 according to the invention no additional assembly effort is involved, since the stator support 5 is only fitted axially between the hybrid housing 4 and the transmission housing 3 without the need for any shape modifications, so that only the axial length of the hybrid drive train is increased.

The flange collar 6 of the stator support 5 has several cut-outs 8, as can be seen particularly clearly in FIGS. 2, 3 and 4. Thanks to the cut-outs 8, on the one hand, the weight of the stator support 5 can be reduced, and, on the other hand, an appropriately positioned cut-out 8 can provide a passage for a throw-out tappet of the clutch. Furthermore, a fixing strip 20 is provided on the stator support 5. Additional components can be held on the fixing strip 20 in the simplest manner.

As can be seen particularly in FIG. 4 the stator support 5 can be attached to a transport security device. This transport security device is in the form of a sheet 9 fixed by bolts to the stator support 5. The purpose of the transport security device is to keep the stator support 5 in its correct position during transport and assembly, without the stator support 5 coming into contact with a rotor 10 of the electric machine 2. The rotor 10 of the electric machine 2 is fixed on the rotor hub 23.

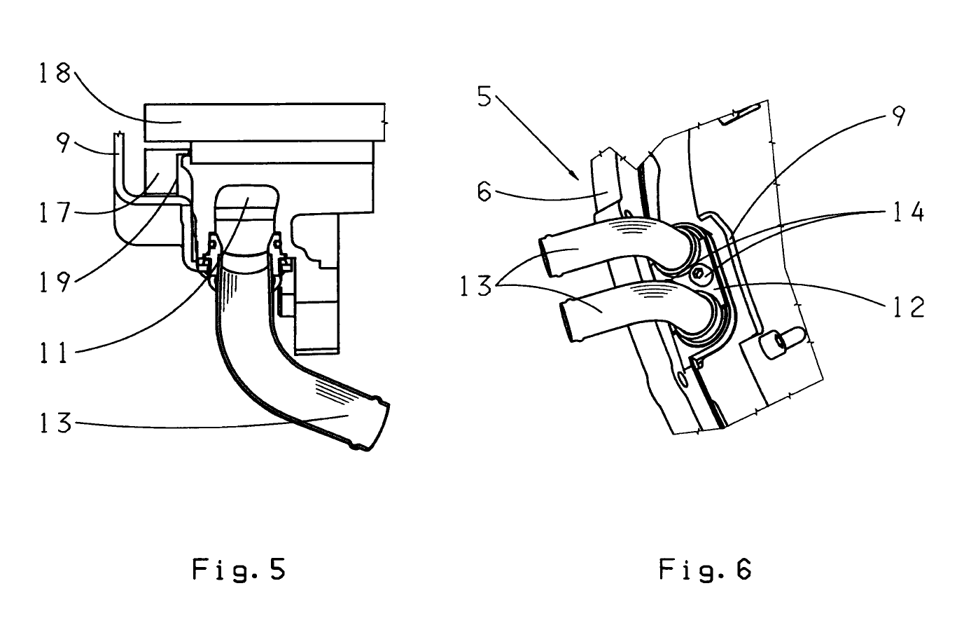

From FIG. 5 it can be seen that the stator support 5 of the electric machine 2 has at least one integrated cooling duct 11 of a cooling system of the electric machine 2. The cooling duct 11 runs within the stator support 5 made, for example, as a casting. As can be seen particularly in FIGS. 5 and 6, the stator support 5 has a coolant connection for the cooling ducts 11 provided in the stator support. The coolant connection is fixed on the stator support 5 by a holding gland 12. In this way the connection pipes 13 are connected to the cooling ducts 11 for the supply of coolant. For example, the coolant used can be water.

FIG. 6 makes it clear that the holding gland 12 for fixing the coolant connection is held tight by two fixing screws 14. If the fixing screws 14 are loosened, the connection pipes 13 can be rotated to a desired position. In this way the connecting pipes 13 can be adapted to specific, previously positioned lines.

To vent the cooling system a main bearing point 15 of the stator support 5 can preferably be used. For this, a venting screw 22 can close off an opening of the main bearing point 15. By screwing out the venting screw 22 as necessary, the cooling system can be vented. The venting screw 22 can be seen in FIG. 1 in particular.

On the stator support 5 there is also fixed an electric current terminal box 16. Into this terminal box 16 run the three electric leads 17 connected to the respective coils 18 between the rotor 10 and the stator support 5 of the electric machine 2, as shown in particular in FIG. 4. Among other things, FIG. 5 shows a current rail 19 in which the leads 17 run, the current rail 19 extending along the outside of the stator support 5.

In addition a temperature sensor connection 20, for example a so-termed NTC plug, is provided on the stator support 5. The temperature sensor connection 20 is arranged on the outside circumference of the stator support 5.

Thus, an electric machine 2 with a compact and integrally formed stator support 5 is created, in which all the connections and interfaces required for operation are brought together.

### INDEXES

1 Clutch fork
2 Electric machine
3 Transmission housing
4 Hybrid housing
5 Stator support
6 Flange collar
7 Through-bore
8 Cut-out
9 Sheet
10 Rotor
11 Cooling duct
12 Holding gland
13 Connection pipes
14 Fixing screws
15 Main bearing point
16 Electric current terminal box
17 Leads
18 Coils
19 Current rail
20 Temperature sensor connection
21 Fixing strip
22 Venting screw
23 Rotor hub

1-11. (canceled)

12. A hybrid drive train of a utility vehicle, the hybrid drive train comprising:
an internal combustion engine, an electric machine (2) with a stator support (5),
a transmission housing (3) for accommodating a transmission,
a hybrid housing (4) for accommodating the electric machine (2), and
a clutch arranged between the internal combustion engine and the electric machine (2),
wherein the stator support (5) is formed integrally with an attachment for fastening to the hybrid housing (4) and to the transmission housing (3), a radially outer flange collar (6) is formed on the stator support (5) as the attachment, and the flange collar (6) has a plurality of cut-outs (8) such that one of a throw-out tappet and thrust rod passes through one of the cut-outs (8).

13. The electric machine according claim 12, wherein the flange collar (6) has a plurality of axial through-bores (7) distributed around a periphery thereof.

14. The electric machine according claim 12, wherein the flange collar (6) has a shape that is adapted to respective contours of the transmission housing (3) and the hybrid housing (4) on an axial side.

15. The electric machine according claim 14, wherein the stator support (5) is clamped axially between the transmission housing (3) and the hybrid housing (4).

16. The electric machine according claim 12, wherein the stator support (5) is connectable to a transport security device.

17. The electric machine according claim 12, wherein the stator support (5) comprises at least one integrated cooling duct (11) of a cooling system for the electric machine (2).

18. The electric machine according claim 17, wherein at least one main bearing point (15) of the stator support (5) is provided with venting means for ventilating the cooling system.

19. The electric machine according claim 12, wherein a peripheral area of the stator support (5) has at least one of a cooling duct connection, an electric current terminal and a temperature sensor connection (20).

20. The electric machine according claim 12, wherein the stator support (5) has a rotor position sensor.

21. An electric machine (2) for a hybrid drive train of a utility vehicle, the electric machine (2) comprising:
a stator support (5) having an integral radially outer flange collar (6), the flange collar (6) being axially sandwiched between a transmission housing (3) and a hybrid housing (4) such that one axial face of the flange collar (6) mating with a surface of the transmission housing (3) and an opposite axial face of the flange collar (6) mating with a surface of the hybrid housing (4);
the flange collar (6) having a plurality of cut-outs (8) which form open passages through the stator support (5) between the transmission housing (3) and the hybrid housing (4); and
the stator support (5) comprising at least one integrated cooling duct (11) which communicates with a cooling system of the electric machine (2).
